(19) United States
(12) Patent Application Publication
(10) Pub. No.: US 2010/0020299 A1
(43) Pub. Date: Jan. 28, 2010

(54) INSTRUMENTATION AND METHOD FOR MASKLESS PHOTOLITHOGRAPHY

(75) Inventor: John A. Zebala, Sammamish, WA (US)

Correspondence Address: Syntrix Biosystems, Inc., 215 CLAY STREET NW, SUITE B-5, AUBURN W, WA, 98001, US

(73) Assignee: Syntrix Biosystems, Inc.

(21) Appl. No.: 12/325,126

(22) Filed: Nov. 28, 2008

Related U.S. Application Data
(60) Provisional application No. 60/991,142, filed on Nov. 29, 2007.

(51) Int. Cl. G03B 27/54

(52) U.S. Cl. 355/67

(57) ABSTRACT

There is disclosed a maskless photolithography apparatus and method where image patterns are determined by the user during visualization of a mounted material on a substrate with a microscope, and the image patterns are dynamically changed during visualization. The maskless photolithography system provides a means for dynamically generating a custom image pattern that depends on micron-scale landmarks in a mounted material without using a photomask.

### CROSS REFERENCE

The present patent application claims priority to U.S. Provisional Patent Application 60/991,142 filed 29 Nov. 2007.

This invention was made with government support under Grant No. 5R44CA099333-03 awarded by the National Institutes of Health. The government has certain rights in the invention.

### TECHNICAL FIELD

The present disclosure provides a maskless photolithography apparatus wherein image patterns are dynamically generated by the user during observation of a substrate with a microscope. The present disclosure further provides a method for generating image patterns and projecting them as light patterns onto a substrate or mounted material thereon using a microscope and the apparatus.

### BACKGROUND

The analysis of cancer within complex heterogeneous tissues represents special challenges posed by the presence of infiltrating nonneoplastic cells. Others have developed laser-based strategies for microdissecting cells of interest away from the nonneoplastic background that include laser catapulting (see U.S. Pat. No. 6,930,764) and laser capture microdissection (see U.S. Pat. No. 6,469,779). The major drawbacks of laser-based methods of laser capture microdissection are at the high level of resources and expertise, with both methods requiring specialized training and costly instrumentation.

An alternative to laser-based microdissection technologies is biolithography, a method for high-resolution tissue microdissection that employs photolithography directly on biologic samples (see, for example, U.S. Pat. No. 6,159,681). Biolithography offers advantages over laser-based methods, including improvements in spatial resolution, reliability, contamination risk, and instrumentation cost.

The methods of biolithography have many process steps similar to those used in semiconductor integrated circuit manufacturing. These methods also often involve the use of fixed photomasks (also referred to as ‘masks’) that have a predefined image pattern which permits the light used for patterning to reach certain regions of a substrate but not others. The use of a fixed photomask in biolithography is untenable, since the cell pattern in a tissue sample is never the same from one sample to another.

Maskless photolithography (see U.S. Pat. No. 5,870,176) is used in the areas of DNA microarray synthesis (see U.S. Pat. Nos. 6,480,324; 6,271,957; 6,295,153). However, these methods fail to allow a user to dynamically define light patterns based on visual examination and selection of regions of interest as is required in biolithography.

There is a need in the art to meet the demands for a low cost, efficient, customizable method of small-scale light patterning for use in biolithography. There is a further need for an improved and simplified system and method for tissue microdissection using biolithography, preferably using maskless photolithography.

### SUMMARY

The present disclosure provides an apparatus and a method that can perform photolithography without the need for photomasks (i.e., “maskless photolithography”). In a preferred embodiment, the maskless photolithography system described herein dynamically generates an image using a computer and reconfigurable spatial light modulator or ‘SLM’ (preferably the SLM is a Digital Micromirror Device or ‘DMD’) using computer generated electronic control signals, without any photomask, to project a light pattern (i.e., electromagnetic radiation) onto a surface of a substrate or mounted material immobilized on the substrate. Preferably, the light pattern is defined by an image pattern created during the user's microscopic observations of the sample.

In a preferred embodiment, the present disclosure provides an apparatus for targeting light to a plurality of regions of a substrate or a mounted material thereon, comprising (a) a body capable of immobilizing a substrate, optionally further comprising a mounted material thereon; (b) a first electromagnetic radiation source that generates a first light; (c) a first optics system that transforms the first light to a first geometry having a first focal plane; (d) a second electromagnetic radiation source that generates a second light that differs in wavelength from the first light; (e) a second optics for transforming the second light to a second geometry having a second focal plane; (f) a SLM that directs the first and second lights to defined regions on the substrate or mounted material (i.e., areas on a substrate or mounted material defined by a stored data file or defined dynamically through visualization by a user, preferably using a microscope); (g) a collection optics that receive response radiation from the substrate or mounted material; (h) a detector that generates a signal proportional to the amount of radiation received by the collection optics, such that the signal represents an image of the substrate and mounted material thereon superimposed with an image of the SLM pixels; and (i) a focuser that controls the distance between the substrate or mounted material and the first and second focal planes. Preferably, the first and second electromagnetic radiation sources are light emitting diodes (LEDs). In other preferred embodiments, the mounted material is a biologic material. The apparatus optionally further comprises an attenuator, such as a shutter, that blocks transfer of the first or second lights to the substrate or mounted material thereon. Alternatively, or in addition, the apparatus further comprises a processor for processing and storing signal from the detector and SLM, and coordinating the attenuator and the focuser to permit irradiation at the plurality of regions.

In a particular embodiment, the present disclosure provides an apparatus for generating a digital image, comprising (a) a light source; (b) a substrate and mounted material with one or more visual landmarks; (c) a microscope with an objective lens; (d) a SLM that directs the light source into the objective lens by transmitting through, or reflecting off, the substrate or mounted material such that a superimposed image of a plurality of SLM pixels and visual landmarks can be visualized by a user, preferably with the microscope; (e) a computer connected to, and controlling the plurality of pixels, and able to transform a state of the SLM into a digital representation, wherein the digital representation is a digital image.

Preferably, the substrate and mounted material are translucent and/or transparent. Preferably, the one or more visual landmarks are selected from the group consisting of organs, tissues, cells, organelles and molecules. Other preferred landmarks include microfabricated circuits, micro-electromechanical (MEMs) structures, photopatterned films, and vapor or wet-etched structures. Preferably, the SLM is a DMD or a liquid crystal device (LCD).

Preferably, the apparatus further comprises (f) a first optics (for light collimation and homogenization) between the light source and the SLM; and (g) a second optics (for light projection) between the SLM and the objective lens. Preferably, the substrate is mounted on a movable platform to allow for a plurality of digital representations to be made from separate or overlapping areas of the substrate or mounted material, wherein the digital image is a merging of the plurality of digital representations. More preferably, at least some of the light relayed by the SLM catalyzes a chemical reaction in the mounted material (i.e. causes the mounted material to substantially react), which in preferred embodiments comprises a photoresist. Preferably, the light source is a plurality of selectable light sources having different wavelengths. Preferably, the device further comprises a means to store the digital image.

In other embodiments, the SLM projects a light pattern onto the surface of the mounted material to form an area to be microdissected from the mounted material, preferably using the process of biolithography wherein the mounted material preferably comprises a tissue section.

The present disclosure provides a system for creating and projecting a digital image, comprising providing a digital image that is dynamically created by a user during microscopic visualization of superimposed images of the SLM pixels and visual landmarks, wherein the user “paints” regions of interest with a first light by turning on or off SLM pixels whose position correspond to the position of the regions of interest. The digital image so created is used to provide a light pattern that is projected with a second light that has the same pixel-to-landmark spatial relationships as during image creation with the first light. Preferably, the digital image is stored in a computer as a digital data file. In preferred embodiments employing the process of biolithography, the mounted material comprises biologic material and a photoresist, wherein the photoresist is a transparent film coated on top of translucent biologic material that undergoes a photochemical reaction with the second light but not with the first light, and that permits visualization of the landmarks in the underlying biologic material. In contrast to fixed photomasks commonly employed in the microfabrication field, the method thus provides light patterns that are dynamically created in response to the unique spatial relationships of landmarks present in a particular mounted material.

The present disclosure further provides a light source of low etendue (for example, a nearly point source or a source of low beam divergence) that produces light of appropriate wavelength and intensity; the light from the source is collected; the light is homogenized to form a “light body” of appropriate size and uniformity; an image of the light body is projected by relay optics to fully illuminate the active surface of a SLM with acceptable uniformity; the beam so formed must be such that when relayed from the SLM as the on-state beam it enters the entrance pupil of the projection lens with low geometric loss and the beam of light must also be restricted in divergence to less than +/−20 degrees, more preferably to less than +/−12 degrees, more preferably to less than +/−10 degrees, to allow the off-state beam to not enter the entrance pupil of the projection lens; and the projection imaging optics collects the on-state light and produces an image of the SLM at the resist plane.

The present disclosure further provides a method for generating a digital image comprising: (a) providing a substrate and mounted material having one or more visual landmarks thereon; (b) aligning a SLM with the mounted material wherein the SLM comprises a plurality of pixels; (c) under visualization of the superimposed image of the SLM pixels and the one or more visual landmarks, causing the pixels of the SLM to assume a state that depends on the position of the one or more visual landmarks in the superimposed image; and (d) transforming the state to a digital representation, and thereby producing a digital image. In preferred embodiments, step (c) comprises painting regions of interest on the mounted material.

Preferably, the method further stores the digital representation in a computer. Preferably, step (b) further comprises relaying a first light of a first wavelength by the SLM, thereby illuminating the substrate or the mounted material. Preferably, the first light does not substantially react with the mounted material, particularly when the mounted material is a photoresist. Preferably, step (c) comprises using a microscope.

Preferably, the method further comprises a step (e) of substituting the first light with a second light of a second wavelength that is different from the wavelength of the first light. Preferably, the second light causes the mounted material to substantially react, particularly when the mounted material comprises a photoresist.

The present disclosure further provides a method for generating a digital image larger than the area of the SLM comprising: (a) providing a substrate or mounted material with one or more visual landmarks thereon; (b) aligning a SLM with the substrate or mounted material wherein the SLM comprises a plurality of pixels; (c) under visualization of the superimposed image of the SLM pixels and the one or more visual landmarks, causing the pixels of the SLM to assume a state that depends on the position of the one or more visual landmarks in the superimposed image; (d) transforming the state to a digital representation; (e) moving the substrate and repeating steps (b)-(d), thereby forming a plurality of digital representations; and (f) merging the plurality of digital representations together, and thereby producing a digital image larger than the area of the SLM. In preferred embodiments the digital representations are stored as digital files that are merged into a digital image using a digital computer.

Step (b) optionally further comprises relaying a first light of a first wavelength by the SLM, thereby illuminating the substrate or the mounted material during the steps involved in producing the digital image. Preferably, the first light does not substantially react with the mounted material, particularly when the mounted material is a photoresist.

In more preferred embodiments, the method projects an area larger than the projected area of the SLM comprising the further steps of: (g) substituting the first light with a second light of a second wavelength that is different from the wavelength of the first light; (h) transforming a portion of the digital image to a SLM state wherein the pixels and visual landmarks have a spatial registration identical to that in steps (b)-(e); (i) moving the substrate; and repeating steps (h)-(i) for a new portion of the digital image, thereby projecting an area larger than the projected area of the SLM. Preferably, the second light causes a chemical reaction in the mounted material, particularly when the mounted material is a photoresist.

Preferably, steps involving moving the substrate in relation to the SLM comprises scrolling the state across the SLM such that the one or more visual landmarks remain in a fixed spatial relationship to at least a portion of the state. Preferably, the plurality of digital representations is from about 2 to about 1000. The digital representations may or may not be overlapping.

### BRIEF DESCRIPTION OF THE DRAWINGS

FIG. 1 is a diagram of an embodiment of a single-light maskless photolithography system.

FIG. 2 is a diagram of an embodiment of a two-light maskless photolithography system.

FIG. 3 is a diagram of an embodiment of an automated two-light maskless photolithography system.

FIG. 4 is an image of a negative photoresist film that was selectively irradiated on the left half as described in Example 3. The right half was substantially removed with developer during processing, resulting in an opening to the underlying biologic material. The dark border indicates the edge of the image.

FIG. 5 is an image of a negative photoresist (SU-8) that was irradiated everywhere except for a 100×100 pixel area (center). This unirradiated area was substantially removed with developer during processing, resulting in an opening in the photoresist film to the underlying biologic material (see Example 4). Dark border indicates edge of image.

FIG. 6 is a image of a negative photoresist (SU-8) that was irradiated everywhere except for a 30×30 pixel area (center). This unirradiated area was substantially removed with developer during processing, resulting in an opening in the photoresist film to the underlying biologic material (see Example 5). Dark border indicates edge of image.

### DETAILED DESCRIPTION

The present disclosure provides a maskless photolithography system that provides a facile and cost-effective method to address the needs in a variety of fields ranging from semiconductor and MEMs processing, to whole organism analysis using, for example, the process of biolithography (U.S. Pat. No. 6,159,681).

### Contents

A. Definitions

B. Single-Light Maskless Photolithography
1. Electromagnetic Radiation Source
2. Collimation and Homogenization Optics
3. Spatial Light Modulators (SLMs)
4. Projection Optics
5. Mounted Material, Substrate and Visualization Means
6. Operation and Method of Use

C. Two-Light Maskless Photolithography
1. Apparatus
2. Alternative Apparatus Embodiments
3. Operation and Method of Use

D. Automated Two-Light Maskless Photolithography
1. Apparatus
2. Operation and Method of Use

E. Examples

### A. DEFINITIONS

The term “ablation” refers to the alteration of a portion or all of biologic material, such that a substance is no longer detectable within an assay that would, in the absence of ablation, provide a detectable response. Such alteration may encompass substantially complete destruction by, for example, extreme radiation, such as from an excimer laser or reactive ion-etch system. Alternatively, the alteration may be relatively mild, resulting in only chemical and/or physical modifications (which may be specific or nonspecific) of molecules in the biologic material. The magnitude of the alteration which must be applied to eliminate an expected detectable response will be readily determined by testing a given alteration at various magnitudes against a representative substance and determining at what magnitude there is no longer a detectable response.

An “ablative agent” is any treatment that results in ablation. These include, but are not limited to: oxidants, free radicals, non-specific nucleases, non-specific ribonucleases, peptide nucleic acid clamps, high energy particles, extremes of radiation, ultrasonic energy, high pressure liquids, ultraviolet irradiation and combinations thereof.

A “biologic material” may be any tissue(s), cell(s), virus(es) or portions thereof (e.g., organelles and membranes and fragments thereof). A biologic material may be one or more molecules of a type or types found in nature (e.g., nucleic acid molecules, proteins, peptides, antibodies, polysaccharides, monosaccharides, lectins and lipids). Other molecules included within the scope of “biologic materials” are nonnaturally-occurring nucleobase polymers as defined herein, which mimic naturally occurring nucleic acid molecules, but contain nucleobases linked by a backbone that is not found in nature. Within the biologic material, visual landmarks are frequently present.

A photoresist is “coated” on a substrate or mounted material thereon if the photoresist forms a continuous layer in the coated area. A coating is sufficiently continuous that virtually no straight-line penetrable discontinuities or gaps are detectable in the coating, as detected using, for example, standard microscopy, phase-contrast microscopy or fluorescence microscopy. Preferably, such straight-line penetrable discontinuities or gaps should comprise less than 20%, and more preferably less than 5% of the surface area of the coating. It will be apparent that any number of discontinuities and gaps may exist in regions not coated. There is no limit on the thickness of the photoresist in order for it to be considered coated on a substrate or mounted material. The thickness of the photoresist can be measured using, for example, profilometers and interferometers. Other requirements for a biologic material to be “coated” in the process of biolithography have been disclosed in U.S. Pat. No. 6,159,681, incorporated by reference herein.

The term “contact” refers to physical contact. For example, a biologic material is contacted with a detection reagent if there is no detectable separation between the biologic material and the reagent. A photoresist is contacted with a developer if a developer composition is contacted with the photoresist, or if irradiation is targeted to the photoresist, such that the photoresist is substantially removed in a specific region. Similarly, a biologic material is contacted with an ablation agent if the agent is contacted with the biologic material or if irradiation that effects ablation of a particular substance is targeted to the biologic material, such that ablation occurs.

A “developer” may be any treatment that dissolves an irradiated portion of a positive photoresist or an unirradiated portion of a negative photoresist, permitting selective removal of the dissolved regions. A developer may be a liquid or gas composition. Certain preferred developers comprise a non-aqueous mixture of solvents containing various ratios of ketone, amino, hydroxyl and amide moieties. Alternatively, a developer may be irradiation.

The term “mounted material” is material that is immobilized onto a surface of a substrate. The mounted material may be biologic material (e.g., organs, tissues, cells, organelles, enzymes, biomolecules), organic material (e.g., small synthetic organic molecules or organic polymers such as photoresists), or inorganic material (e.g., glass, Si, Ge, GaAs, GaP, SiO₂, SIN4, modified silicon, silane layers). The mounted material may be patterned (e.g., having visual landmarks) or unpatterned.

The term “paint” or “painting” refers to a process comprising at least the steps of: (a) aligning a SLM to visual landmarks such that the images of landmarks and pixels are superimposed; (b) visually selecting regions of interest based on the spatial position of visual landmarks; and (c) within the selected regions of interest modulating the pixel, or plurality of pixels, of the SLM such that the pixel, or plurality of pixels, of the SLM assume a particular state (i.e., either all ‘on’ or all ‘off’ pixels).

A “photomask” or “mask” is a barrier that selectively permits the passage of irradiation to designated regions of a target photoresist. A mask may be a substantially transparent support material with substantially opaque regions in a precise pattern where it is desired that light be blocked when one side of the mask is illuminated. In some embodiments the substantially opaque regions are derived through a photographic process using a photoplotting device (e.g., as in masks commonly used in printed circuit board manufacturing). In other embodiments the mask is derived from a substantially transparent support material coated with a substantially opaque material which is photoablated by a narrowly focused laser producing precisely defined transparent regions (e.g., chrome on glass masks).

The term “photoresist” refers to a material that, upon irradiation, sustains a chemical reaction that allows irradiated and non-irradiated regions to be separated from one another. Although the separation may be simultaneous with irradiation (e.g., in laser ablation), it often requires an additional process step or steps (e.g., exposure to a developer). The chemical reaction may involve the formation or breakage of chemical bonds with such bond changes occurring in either an intramolecular or intermolecular fashion. In most applications, a photoresist is applied to a flat surface as a relatively thin liquid layer and evaporated. A “negative photoresist” refers to a photoresist that leaves photoresist on the surface in irradiated regions, while a “positive photoresist” refers to a photoresist that leaves photoresist on the surface in regions that were not irradiated. Unirradiated photoresist is not covalently attached to the substrate. Properties of photoresists suitable for use with the process of biolithography have been disclosed (U.S. Pat. No. 6,159,681).

The term “pixel” refers to the smallest physical element in a SLM that can modulate light.

The term “region of interest” is a region of a substrate or mounted material on which light is to be differentially modulated relative to regions not of interest. This may involve selectively illuminating, or selectively not illuminating, a region of interest relative to regions not of interest. Typically a region of interest will be occupied by visual landmarks, or at least have visual landmarks in close adjacent proximity, that will permit a user to visually identify the area as a region of interest. As employed in the process of biolithography (U.S. Pat. No. 6,159,681), a region of interest typically involves landmarks in the biologic material that are distinct from landmarks in regions not of interest (e.g., cancerous vs. noncancerous cells). In non-biologic applications, regions of interest may involve microfabricated structures on the substrate, and the regions of interest are, for example, intended to define the areas where new microfabricated structures are to be placed. In this case, landmarks will lie outside the regions of interest.

A “spatial light modulator” or “SLM” is a device that modulates light. A SLM, as used herein, may also be referred to as a “light valve” in the art. SLMs can be micromachined mechanical modulators or microelectronic devices, for example, a liquid crystal display (LCD). A SLM may be electronically controlled by a computer to generate unique image patterns. A SLM may direct light to defined regions on the substrate or mounted material by either light transmission or light reflection (i.e., areas on a substrate or mounted material defined by a stored data file or defined dynamically through visualization by a user, preferably using a microscope). An LCD modulates light transmission. One type of mechanical modulator that modulates light by reflection is a micromirror array or digital micromirror device (DMD) manufactured by Texas Instruments, Inc. (Dallas, Tex., USA), which uses small metal mirrors to selectively reflect a light beam.

The term “state” refers to the orientation of a pixel within a SLM, such that the pixel is in an “on” (capable of relaying light) or “off” (incapable of relaying light) state. For example, a micromirror array is illuminated 20 degrees off axis. Each mirror can be turned to an “on state” (tilted 10 degrees in one direction) or “off state” (tilted 10 degrees in the other direction). A lens (on axis) images the micromirror array onto a target. When a micromirror is turned “on”, light reflected by the micromirror passes through the lens and the image of the micromirror on the substrate or mounted material appears bright. When a micromirror is turned “off”, light reflected by the micromirror misses the lens and no image of the micromirror forms on the substrate or mounted material. The micromirror array can be reconfigured by software (i.e., any micromirror in the array can be turned “on” or “off” as desired) in a fraction of a second. When used in reference to an entire SLM, the term “state” refers to the collective states of all pixels in the device.

“Stripping” refers to the substantial removal of photoresist by strippers. Strippers are liquid chemical media used to remove photoresists after processing is finished. The exact composition depends on the composition of the photoresist.

The phrase “substantially react” refers to effecting a substantial molecular change. Within the methods described herein, a light does not “substantially react” with a photoresist if it is insufficient to result in substantial removal of irradiated positive photoresist, or insufficient to prevent substantial removal of irradiated negative photoresist. Whether a light “substantially reacts” with a photoresist or not, depends on the wavelength, duration and intensity of the light, as well as the nature of the photoresist. In some embodiments, a light that does not “substantially react” with a photoresist may still result in detectable changes in a photoresist. For example, such a light may result in the removal of several tens of nanometers of the surface of a positive photoresist, which would be detectable by sensitive methods such as interferometry. Alternatively, such a light may result in a small number of cross-linking reactions in a fraction of the polymeric component of a negative photoresist, which would be detectable by sensitive methods such as gel permeation chromatography. The differential between the changes induced in a photoresist by lights that do and do not “substantially react” as a percentage of changes induced by a light that does “substantially react” should be greater than 75%, more preferably greater than 90%, and most preferably greater than 99.9%. Importantly, the differential should be sufficient to permit irradiation of photoresist as described above. Similarly, a process or reagent does not “substantially react” with a biologic material if contact with such process or reagent does not result in a substantial change to a detectable response from either an assay or a detection reagent that would otherwise occur in the absence of such a process or reagent (e.g., see definition of “ablation” above for examples of agents that result in substantial changes to detectable responses). As discussed with light above, a process or reagent that does not “substantially react” with a biologic material may in some embodiments still result in detectable changes in the biologic material. Such changes could include, for example, covalent modification of the material, or in a modification of a physical property (e.g., antigenicity, reactivity, adhesion properties of cells, integrity of membranes or cellular organelles, and enzymatic activity). The important characteristic of a process or reagent that does not “substantially react” with a biologic material, however, is that a desired detectable response from the biologic material is substantially similar in the presence or absence of the process or reagent. In preferred embodiments, the detectable response is not altered by more than 50%, 25%, and most preferably 5%.

Photoresist is said to be “substantially removed” from a substrate or mounted material when the substrate or mounted material is no longer “coated” with photoresist, as described above.

A “substrate,” is any solid object on which a mounted material may be optionally immobilized. Essentially any conceivable substrate may be used within the methods provided herein, including biological, nonbiological, organic and inorganic substrates, as well as substrates that are a combination of any of these. The substrate may have any convenient shape, such as a disc, square, sphere, circle, or any other suitable shape, and may be formed, for example, as a particle, strand, precipitate, gel, sheet, tubing, sphere, container, capillary, pad, slice, film, plate or slide. The substrate preferably forms a rigid support on which to support a mounted material, and is preferably flat, although it may take on a variety of alternative surface configurations, including having raised and/or depressed regions. The substrate may be prepared from essentially any material. For instance, a substrate may comprise functionalized glass, Si, Ge, GaAs, GaP, SiO₂, SIN4, modified silicon, photoresist, biolayers, silane layers or any one of a wide variety of polymers such as polytetrafluoroethylene, polyvinylidenedifluoride, polystyrene, polycarbonate, polyethylene, polypropylene, nylon or combinations thereof. Substrates also include silicon on insulator structures, epitaxial formations, germanium, germanium silicon, polysilicon, amorphous silicon, glass, quartz, or gel matrices and/or like substrates, non-conductive, semi-conductive or conductive. In a preferred embodiment the substrate is flat glass. The surface of a substrate may, but need not, be composed of the same material as in the body of the substrate. Surface materials include, but are not limited to, polymers, plastics, resins, polysaccharides, silica or silica-based materials, carbon, metals, inorganic glasses, membranes or any of the above-listed substrate materials. Preferably, the surface contains reactive groups, such as carboxyl, amino and/or hydroxyl groups. Most preferably, the surface will be optically transparent and will have surface Si-OH functionalities, such as are found on silica surfaces. Surfaces are also preferably rigid.

The term “visual landmark” refers to regions of the substrate or mounted material that can be visually distinguished, typically with the aid of optical magnification (e.g., a microscope). For example, cancerous cells in a tissue section are landmarks that can be distinguished visually from noncancerous cells. In a semiconductor example, existing micro-circuitry or MEMs provide landmarks that can be visually distinguished.

### B. SINGLE-LIGHT MASKLESS PHOTOLITHOGRAPHY

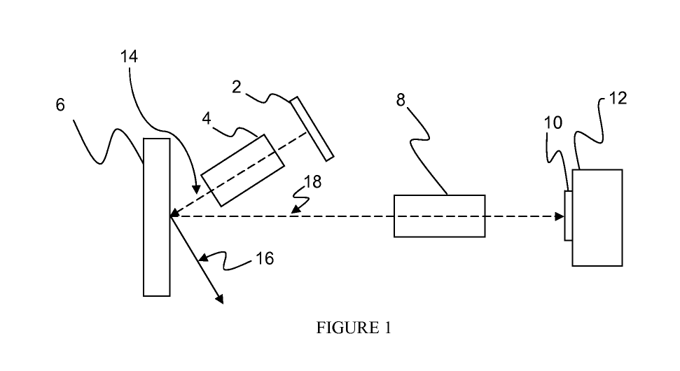

One embodiment of an apparatus and method is a single-light maskless photolithography system wherein an image pattern is dynamically generated by a user during visualization of the substrate and mounted material thereon, preferably with a microscope. The image pattern is defined by the user during direct observation of the substrate and/or mounted material thereon. An embodiment of a single-light maskless photolithography apparatus is shown in FIG. 1. The embodiment comprises electromagnetic radiation source 2, collimation and homogenization optics 4, SLM 6, projection optics 8, mounted material 10 and a substrate 12.

1. Electromagnetic Radiation Source For the electromagnetic radiation source 2, nearly all electromagnetic radiation sources are suitable, and may include, for example mercury, xenon, metal-halide, fluorescent, tungsten and halogen lamps. In some embodiments, the choice of the electromagnetic radiation source will be dictated by the wavelength and intensity of the light, where the particular combination of wavelength and intensity is known to either cause, or not cause, the light to substantially react with the mounted material, particularly when the mounted material comprises a photoresist. Determining the particular combination of wavelength and intensity that will react with a particular photoresist is known to those skilled in the art. Accordingly, in some embodiments the electromagnetic radiation source further comprises a bandpass filter to restrict the particular wavelength range emitted from the electromagnetic radiation source. Selection of an appropriate bandpass filter is dependent on, among other things, the requisite image size to be formed on the substrate, the type of SLM, the type of light source, and the photochemical properties of the photoresist (e.g., wavelength and dose sensitivity). In preferred embodiments where the photoresist is sensitive to g-line and i-line radiation, a bandpass filter having a wavelength range of 365-410 nm is appropriate. Electromagnetic radiation sources that by their nature emit the appropriate wavelength of light do not require a bandpass filter. Thus, preferred embodiments employ an LED with a restricted band of light wavelengths as the electromagnetic radiation source. For example, the Nichia NCCU033 High Power Chip Type UV LED (Nichia, Tokyo, Japan) will emit a majority of light having a wavelength of 365 nm, whereas the Luxeon III Star Amber LED P/N LXHL-LL3C (Philips Lumileds Lighting Company, San Jose, Calif., US) will emit a majority of light having a wavelength of 590 nm.

2. Collimation and Homogenization Optics

A large variety of configurations for the collimation and homogenization optics 4 will be apparent to those skilled in the art. In a preferred embodiment, the collimation and homogenization optics comprise in order from the light source: (a) a collimating lens system, (b) a focusing lens, (c) a mirror tunnel and (d) an illumination lens relay system. In one embodiment, the collimating lens system is a commercially available first and second aspheric lens that collects the light from light source 2 and collimates it. The collimated beam is focused into the input opening of the mirror tunnel by the focusing lens; e.g., a commercially available plano-convex lens.

The mirror tunnel provides for homogenization of the light. Preferably, the light source is magnified by the collimating lens system and focusing lens with sufficient image quality to reduce the angular divergence of the light source to within +/−25 degrees while still assuring that a large fraction (typically greater than 80%) of the light output from the light source is captured by the mirror tunnel to provide sufficient intensity. A light source with low entendue is preferred (for example, a nearly point source or a source of low beam divergence).

The mirror tunnel preferably has a rectangular cross-section with inside mirror faces. Light emerging from the mirror tunnel is formed into a light body of the size and shape of the exit opening of the mirror tunnel. The angular divergence of the exiting rays is the same as those entering the mirror tunnel. Preferably, the spatial nonuniformity of light intensity exiting the light tunnel is less than 30%, more preferably less than 20%, and most preferably less than 10%, where nonuniformity=100 (max−min)/(max+min), max and min are the maximum and minimum intensities, respectively.

The illumination lens relay system collects light exiting the mirror tunnel and forms an image of the light body on the SLM 6 with light beams 14. The illumination relay lens system is preferably telecentric in both object and image space. When the SLM is a DMD (see below), the relay lens system preferably provides a magnification of about 2.3, high (near 100%) collection efficiency, imaging sufficient to minimize losses at the edge of the DMD (i.e., a RMS spot radius of less than 0.5 mm), and a diameter and working distance which, together with the geometry of the projection optics 8, allows light beams 18 of on-pixels to be relayed by the DMD into the projection optics without vignetting over a range of wavelengths (e.g., 360-550 nm in preferred embodiments). A low beam divergence from the illumination lens relay system is essential to restrict light beams 16 from off-pixels from entering the projection optics 8. In preferred embodiments the majority of rays 14 from the illumination lens relay system have a divergence less than +/−12 degrees.

3. Spatial Light Modulators (SLMs)

A variety of SLMs are possible for the SLM 6. It will be understood by those skilled in the art that different SLMs will alter the optical configuration relative to the embodiment shown in FIG. 1, which illustrates the use of a reflective DMD as the SLM. For example, if a transmissive LCD were employed as the SLM, the optical configuration is an axial arrangement, with the collimation and homogenization optics on one side of the LCD and the projection optics on the other side. For SLMs to be of utility as disclosed herein, the contrast ratio between an ‘off’ and ‘on’ pixel should be at least 2:1, more preferably at least 5:1, more preferably at least 10:1, and most preferably at least 100:1.

In preferred embodiments, the SLM is a DMD manufactured by Texas Instruments, Inc. (Dallas, Tex., US). Suitable DMDs include, for example, a VGA version (640×480 mirrors), super VGA version (800×600 mirrors) and a 0.7XGA 12° DDR version (1024×768 mirrors). Each mirror is 16 μm×16 μm for the VGA and SVGA versions; approximately 13.7 μm×13.7 μm for the 0.7XGA 12° DDR version, and there are approximately 1 μm gaps between mirrors in all versions. In other embodiments, the DMD is conveniently obtained by using a commercially available DMD projector having other subsystems, including for example, a light source, a color filter wheel, a projection lens, and electronics for driving the DMD and interfacing to a computer. In these embodiments, all subsystems except the electronics for driving the DMD are preferably disabled or removed entirely to permit computer control of the DMD.

The DMD is illuminated by light beam 14 20 degrees off axis (12 degrees for the 0.7XGA version). Each mirror in the DMD can be deflected at an angle about a hinged diagonal axis. By appropriate electronic control, each mirror (i.e., pixel) is independently set to one of two deflection polarities: +12 degrees or −12 degrees. If the pixel is set to ‘on’ (+12 degrees), the light beam 14 is deflected toward the projection lens 8 as light beam 18 so that an image of the pixel is formed at the image plane of mounted material 10 or substrate 12. If the pixel is set to ‘off’ (−12 degrees), the light beam 14 is deflected away from the projection lens as light beam 16, and so the corresponding position in the image plane will be dark. Gray level images are optionally formed by duty factor modulation.

In another preferred embodiment, the SLM is the Grating Light Valve (GLV) available from Silicon LightMachines, Sunnyvale, Calif., US. The GLV relies on micromachined pixels that are programmed to be either reflective or diffractive (see http://siliconlight.com).

Other SLMs may also be used as described in the Electronic Engineers' Handbook, 3^{rd} Ed., Fink and Christiansen, Eds., McGraw-Hill Book Co., New York (1989). Deformable membrane mirror arrays are available from Optron Systems Inc. (Bedford, Mass., US). LCDs are available from Hamamatsu (Bridgewater, N.J., US), Spatialight (Novato, Calif., US), and other companies. LCDs are susceptible to damage by certain wavelengths (e.g., short UV), and thus SLM selection should take into consideration the exposure requirements, if any, of the mounted material, particularly when it is a photoresist. Liquid-crystal displays (e.g., in calculators and notebook computers) are also SLMs useful for photolithography particularly to synthesize large features, and reduction optics may be required to achieve pixel images smaller than the actual pixel size.

Transmissive SLMs (e.g., an LCD) that modulate transmitted light can offer certain advantages over reflective SLMs (e.g., a DMD) that modulate reflected light. Reflective SLMs require a large working distance between the modulator and the projection optics so that the projection optics do not block the incident light to the active surface of the SLM. Designing high-performance projection optics with a large working distance is more challenging than designing projection optics of equivalent performance with no constraints on the working distance. In contrast, the working distance of a transmissive SLM does not have to be long and therefore the design of the projection optics is less constrained. In some embodiments, a transmissive SLMs may be used in proximity or contact printing with no projection optics at all, by locating the modulator very close to the substrate.

In still other SLM embodiments, the SLM is an LED array or a semiconductor laser array that directly emits light pixels of the appropriate wavelength, each of which not only may be operated to dynamically define a desired image but also act as the light source, thereby obviating the need for a separate light source.

In other embodiments, extremely high resolution can be obtained by imaging the SLM (e.g., DMD or GLV) using reduction optics comprising an array of micro-lenses or non-imaging light concentrators, where each element of the array demagnifies and focuses one pixel of the SLM. Further optics, including a shaping lens may be included to translate light from a light source onto the active surface of the SLM.

For example, if an SVGA DMD is imaged with 1:1 magnification onto a micro-lens array, an appropriate micro-lens array can comprise of 800×600 lenses (micro-lenses) with 17 μm center-to-center spacing. Alternatively, the micro-lens array can comprise 400×300 17 μm diameter lenses with 34 μm center-to-center spacing, and with opaque material (e.g., chrome) between micro-lenses. One advantage of this alternative is that cross-talk between pixels is reduced. The light incident upon each micro-lens can be focused to a spot size of 1-2 μm.

Because the spot size is much less than the spacing between micro-lenses, a 2-axis translation stage (having, in these examples, a range of travel of at least either 17 μm×17 μm or 34 μm×34 μm) is necessary if complete coverage of the substrate is desired.

Micro-lenses can be diffractive, refractive, or hybrid (diffractive and refractive). Refractive micro-lenses can be conventional or gradient-index. Alternatively an array of non-imaging light concentrators can be employed. An example of such an approach includes a short piece of optical fiber which may be tapered to a small tip.

4. Projection Optics

For the projection optics 8, a large variety of configurations will be known to those skilled in the art that will accept and transmit light beam 18 to substrate 12 and mounted material 10. The projection optics preferably comprises a symmetric lens system (e.g., lenses arranged by type A-B-C-C-B-A) with a working distance of 10 mm to 1 cm, more preferably 70 mm. A symmetric lens system used at 1:1 magnification (object size is the same as the image size) is desirable because certain aberrations (distortion, lateral color, coma) are minimized by symmetry. Further, a symmetric lens system results in a relatively straightforward lens design because there are only half as many variables as in an asymmetric system having the same number of surfaces. In a preferred embodiment, the light transmission of the lens system measured at the image plane is about 20%. At 1:1 magnification the calculated maximum projected image area for a DMD is 10.88 mm×8.16 mm for a VGA device and 10.2 mm×13.6 mm for an SVGA device. The magnification can be greater than or less than 1 depending on the desired size of the projected image area.

In certain embodiments, a relatively simple lens system, such as a back-to-back pair of achromats or camera lens, is adequate. A particularly useful lens system in some embodiments is the Rodenstock (Rockford, Ill.) Apo-Rodagon D. This lens is optimized for 1:1 imaging and gives good performance at magnifications up to about 1.3:1. Similar lenses are available from other manufacturers. With such lenses, either the Airy disk diameter or the blur circle diameter will be rather large (maybe 10 μm or larger) (see Modern Optical Engineering, 2nd Edition, Smith, W. J., ed., McGraw-Hill, Inc., New York (1990)). However, for high-performance embodiments that require images having micron-scale feature sizes, the feature size is several times larger than the Airy disk or blur circle. Therefore, a custom-made lens system with resolution of about 1-2 μm over a 12.8 mm×12.8 mm field is particularly desirable.

5. Mounted Material, Substrate and Visualization Means

Mounted material 10 is in contact with substrate 12. The mounted material may be any material, but in preferred embodiments comprises biologic material coated with a layer of photoresist. In more preferred embodiments the biologic material is a tissue section. The mounted material preferably also has one or more visual landmarks. Light beam 18 from projection optics 8 makes a light pattern at an image plane located at mounted material 10, and optionally also at the surface of substrate 12. In preferred embodiments, the light pattern causes a photoresist in the mounted material to substantially react where the light pattern contacts the photoresist.

The substrate and mounted material may be independently opaque, translucent or transparent. In preferred embodiments, the substrate is transparent glass, and the mounted material comprises a translucent biologic material coated with a transparent photoresist, whereby a user can examine the biologic material by visualizing it through either the photoresist coating or through the body of the substrate. Preferably, the substrate is mounted on a movable platform.

Visualization of the light pattern at the image plane may be performed unaided by the user using the naked eye. Preferred embodiments employ the use of a microscope for visualization. In preferred embodiments, visualization of the light pattern at the image plane either unaided or with the aid of a microscope provides a superimposed image of both the light pattern and the one or more visual landmarks on the mounted material, and further optionally permits the user to dynamically generate the light pattern in response to the one or more visual landmarks on the mounted material.

Depending on the optical properties of the mounted material and the substrate, visualization of the light pattern will be by examination of the image plane directly through the ambient air, or indirectly by examination through the substrate and possibly also through the mounted material. In preferred embodiments, the optical properties of the substrate and mounted material are such that visualization is through the substrate and the mounted material using an inverted microscope; for example the Olympus IX71 or Olympus IX81 inverted microscope (Center Valley, Pa., US). An inverted arrangement that visualizes the mounted material through the substrate is beneficial because it permits the microscope to be readily accommodated without physically interfering with the other components of the apparatus (e.g., projection optic, SLM, etc.).

6. Operation and Method of Use

In operation, collimated and homogenized light 14 from the light source 2 is reflected as light 18 by ‘on’ pixels in SLM 6, and transmitted through the projection optics 8 onto an image plane located at the mounted material 10, and optionally also at a surface of substrate 12. Reflected light 16 from ‘off’ pixels in SLM 6 is reflected in a direction away from projection optics 8 so that the projected images of these pixels appear dark at the image plane. The aggregate of all on and off pixels in SLM 6 produces a final SLM state and final light image at the image plane. The SLM state may be transformed into a digital representation that represents a digital image. In preferred embodiments, the digital representation is stored as a digital file in a computer.

In one embodiment a method is provided that generates a light exposure of the mounted material comprising the steps of: (a) providing a substrate 12 with mounted material 10 having one or more visual landmarks thereon; (b) aligning SLM 6 with the mounted material; and (c) under visualization of the superimposed image of the SLM pixels and the one or more visual landmarks, causing the pixels of the SLM to assume a state that depends on the position of the one or more visual landmarks in the superimposed image, and thereby generating a light exposure of the mounted material.

Causing the pixels of the SLM to assume a state in step (c) may be accomplished by sending a stored digital file to the SLM that is a digital representation of a digital image, or more preferably, by the user dynamically modulating the state of the SLM during visualization. In preferred embodiments, this comprises painting regions of interest on the mounted material with either all ‘on’ or all ‘off’ pixels.

In another preferred embodiment, a method is provided for generating a light exposure of the mounted material larger than the projected area of the SLM further comprising moving the substrate and repeating steps (b)-(c), and repeating these steps as required to generate a light exposure of the mounted material larger than the projected area of the SLM.

In another preferred embodiment, a method is provided for generating a digital image comprising steps (a) through (c), and further comprising a step (d) of transforming the SLM state to a digital representation, and thereby producing a digital image. In another preferred embodiment, a method is provided for generating a digital image larger than the area of the SLM further comprising the step (e) of moving the substrate and repeating steps (b)-(d), thereby forming a plurality of digital representations; and a step (f) of merging the plurality of digital representations together, and thereby producing a digital image larger than the area of the SLM. In preferred embodiments the digital representations are stored as digital files that are merged into a digital image using a digital computer.

A preferred embodiment implements the method of biolithography, wherein a user observes the mounted material and substrate, preferably a tissue section on a glass slide, with an inverted microscope with magnification, preferably 40× magnification, for regions of interest in the mounted material. A digital image is generated and stored as a digital file by the user, as described above, that defines the regions of interest in the mounted material as either on or off pixels depending on whether a positive or negative photoresist is employed, respectively. The mounted material is then coated with a photoresist (e.g., a novalak diazonapthoquinone positive resist or an SU-8 negative resist). The substrate and the mounted material is then submitted back to the apparatus and the digital image is retrieved, causing the SLM to assume a state that projects the light image onto the photoresist for the appropriate duration causing the photoresist to substantially react in regions contacted with light. The photoresist is then developed and etched.

### C. TWO-LIGHT MASKLESS PHOTOLITHOGRAPHY

A preferred embodiment of an apparatus and method is a two-light maskless photolithography system wherein a digital image is dynamically created by a user during visualization of superimposed images of SLM pixels and visual landmarks using a first light. The digital image so created is used to provide a light pattern that is projected with a second light that has the same pixel-to-landmark spatial registration as during image creation with the first light. In preferred embodiments, the second light but not the first light, causes the mounted material to substantially react, thereby allowing added control through separation of the two light-mediated processes of (1) image creation and (2) causing the mounted material to substantially react.

1. Apparatus

One embodiment of a two-light maskless photolithography apparatus comprises (a) a body capable of immobilizing a substrate, optionally further comprising a mounted material thereon; (b) a first electromagnetic radiation source that generates a first light; (c) a first optics system that transforms the first light to a first geometry having a first focal plane; (d) a second electromagnetic radiation source that generates a second light that differs in wavelength from the first light; (e) a second optics for transforming the second light to a second geometry having a second focal plane; (f) a SLM that directs the first and second lights to defined regions on the substrate or mounted material (i.e., areas on a substrate or mounted material defined by a stored data file or defined dynamically through visualization by a user, preferably using a microscope); (g) a collection optics that receive response radiation from the substrate or mounted material; (h) a detector that generates a signal proportional to the amount of radiation received by the collection optics, such that the signal represents an image of the substrate and mounted material thereon superimposed with an image of the SLM pixels; and (i) a focuser that controls the distance between the substrate or mounted material and the first and second focal planes.

Considerations as to the type and selection of the (a) substrate, mounted material and visualization means, (b) first and second optics, (c) first and second electromagnetic radiation sources, and (d) the SLM will be the same as previously described for the single-light maskless photolithography apparatus (see section B. Single-Light Maskless Photolithography).

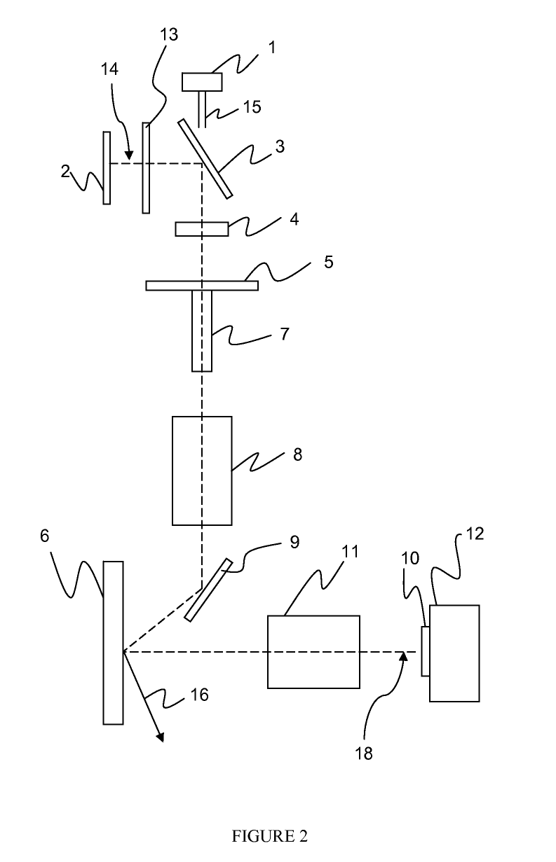

A preferred embodiment of a two-light maskless photolithography apparatus is shown in FIG. 2. A first light 15 emanates from a first electromagnetic radiation source and collimating optics 1. In a preferred embodiment, the first light has a wavelength in the range of 500 nm to 700 nm, and will not substantially react with the mounted material. The collimated first light is transmitted by a dichroic mirror 3.

A second light 14 emanates from a second electromagnetic radiation source 2. In a preferred embodiment, the second light will have a wavelength in the range of 350 nm to 420 nm, and substantially reacts with the mounted material. The second light is collected and collimated by a collimating lens system 13, preferably two off-the-shelf aspheric lenses, available commercially, for example, from OptoSigma (Santa Ana, Calif., US). The collimated second light is reflected from the dichroic mirror 3.

The first and second lights relayed by the dichroic mirror then follow an identical optical path. The lights are focused into the input opening of a mirror tunnel 7 by an off-the-shelf plano-convex lens 4. A rectangular aperture 5 blocks rays not entering the mirror tunnel 7. A mirror tunnel is a rectangular tunnel composed of walls that are mirrored on their interior surfaces. Rays entering the mirror tunnel make many bounces before emerging from the exit face. On the entrance face, the light intensity cross-section is an image of the source. On the exit face, the rectangular opening is uniformly filled to form a light body and thus the light tunnel homogenizes light. An illumination lens relay system 8 projects a magnified image of the light body (exit face of mirror tunnel 7) onto a SLM 6 that is a DMD. In some embodiments, the illumination relay lens 8 is formed from four off-the-shelf optical elements and an internal aperture. A front surface mirror 9 folds the illumination optical path away from substrate 12 to provide adequate clearance between the optics and the substrate.

2. Alternative Apparatus Embodiments

In another embodiment, at least two SLMs, preferably DMDs, are interleaved in order to produce a greater number of pixels on the mounted material, each with the same reticle dimension, thereby eliminating the need for step and repeat processing. Interleaved SLMs also provide for minimizing boundary errors. Further, increasing the pixel array size by interleaving SLMs also provides for increasing resolution, thereby improving the quality of the image projected onto the mounted material. For example, a two-dimensional array of pixels is produced by interleaving two separate DMDs horizontally such that columns of the first micromirrors alternate with columns of the second micromirrors. Thus, columns of alternating pixels are written wherein the first column of the alternating pixels is written by the first (upper) micromirror array and the second column of the alternating pixels is written by the second (lower) micromirror array.

In another preferred embodiment, rows of DMDs, are interleaved vertically in time rather than in space, by loading a new image and pulsing the light source every time the substrate moves one row. Odd and even numbers of the image are multiplexed together in time. At time t=tₒ the odd rows of the image will be imaged by data residing in ‘open’ data registers. These data control the orientation of the micromirrors (causing them to be tilted either into a reflecting “on” position or non-reflecting “off” position). During this step, data describing printing in the even rows is stored in ‘hidden’ registers. At time t=tₒ+Δt, the data controlling the orientation of micromirrors has moved down one register such that data that was stored in the ‘hidden’ data registers are now moved into the ‘open’ data registers and control the micromirrors and thus even rows are now imaged; data that was stored in the ‘open’ data registers are now in the ‘hidden’ data registers. At time t=tₒ+2Δt, the data controlling the micromirrors has moved down another position and once again the odd rows are imaged. In this way a single data point can be converted into one pixel on the mounted material from one micromirror to another micromirror.

3. Operation and Method of Use

In operation, collimated and homogenized first or second lights are reflected as light 18 by ‘on’ pixels in SLM 6, and transmitted through the projection optics 11 onto an image plane located at the mounted material 10, and optionally also at a surface of substrate 12. Reflected light 16 from ‘off’ pixels in SLM 6 is reflected in a direction away from projection optics 11 so that the projected images of these pixels appear dark at the image plane. The aggregate of all on and off pixels in SLM 6 produces a final SLM state and final light image at the image plane. The SLM state may be transformed into a digital representation that represents a digital image, and the digital representation stored as a digital file, preferably in a computer.

By switching between first and second lights, the wavelength of the light image can be modulated in a straightforward manner. In embodiments where the second light but not the first light, causes the mounted material to substantially react, the ability to switch between reactive and non-reactive wavelengths is critical to separating the two processes of dynamic image creation and light-mediated transformation of the mounted material.

In one embodiment a method is provided that generates a light exposure of the mounted material comprising the steps of: (a) providing a substrate 12 with mounted material 10 having one or more visual landmarks thereon; (b) aligning SLM 6 with the mounted material and relaying the first light 15 by the SLM to illuminate the mounted material; (c) under visualization of the superimposed image of the SLM pixels and the one or more visual landmarks, causing the pixels of the SLM to assume a state that depends on the position of the one or more visual landmarks in the superimposed image; and (d) substituting the first light with second light 14 without changing the state of the SLM.

Causing the pixels of the SLM to assume a state in step (c) is accomplished by sending a stored digital file to the SLM that is a digital representation of a digital image, or more preferably, by the user dynamically modulating the state of the SLM during visualization. In preferred embodiments, this comprises painting regions of interest on the mounted material with either all ‘on’ or all ‘off’ pixels. Similarly, the process of switching between first and second lights to project the same image with a different wavelength in step (d) may be accomplished by sending a stored digital file to the SLM. Preferably, the mounted material substantially reacts with the second light but not the first light, particularly when the mounted material is a photoresist. Preferably, step (c) comprises using a microscope.

In another preferred embodiment, a method is provided for generating a light exposure of the mounted material larger than the projected area of the SLM, further comprising moving the substrate and repeating steps (b)-(d), and repeating these steps as required to generate a light exposure of the mounted material larger than the projected area of the SLM.

In another preferred embodiment, a method is provided for generating a light exposure of the mounted material larger than the projected area of the SLM further comprising the steps of: (a) providing a substrate 12 with mounted material 10 having one or more visual landmarks thereon; (b) aligning SLM 6 with the mounted material at a defined location and relaying the first light 15 by the SLM to illuminate the mounted material; (c) under visualization of the superimposed image of the SLM pixels and the one or more visual landmarks, causing the pixels of the SLM to assume a state that depends on the position of the one or more visual landmarks in the superimposed image; (d) storing the state and defined location in a digital file; (e) moving the substrate to another defined location and repeating steps (b)-(d); and (f) substituting the first light with the second light 14 and then causing the SLM to assume the stored state at each of the defined locations stored in the digital file, thereby generating a light exposure of the mounted material larger than the projected area of the SLM.

In preferred embodiments, repeating step (d) in the above method results in a plurality of stored states or digital representations that are merged together to produce a digital image larger than the area of the SLM. In preferred embodiments the digital representations are stored and merged using a digital computer. Preferably, the plurality of digital representations is from about 2 to about 1000. The digital representations may or may not be overlapping. Preferably, step (e) involving moving the substrate in relation to the SLM comprises scrolling the state across the SLM such that the one or more visual landmarks remain in a fixed spatial relationship to at least a portion of the state.

### D. AUTOMATED TWO-LIGHT MASKLESS PHOTOLITHOGRAPHY

A preferred embodiment of an apparatus and method is an automated two-light maskless photolithography system. Automation of the apparatus and method offer further control and convenience to the already added control offered by the two-light system in separating (1) image creation and (2) photoreactions in the mounted material.

1. Apparatus

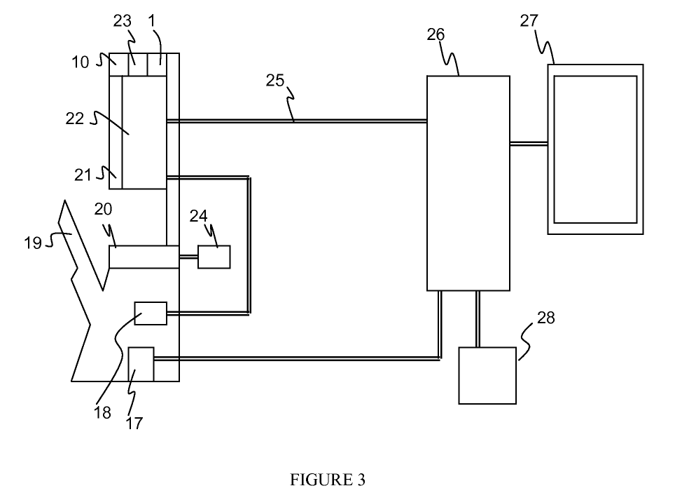

A preferred embodiment of an automated two-light maskless photolithography apparatus is shown in FIG. 3. Refer to section ° C. Two-Light Maskless Photolithography for teachings concerning two-light maskless photolithography not specifically addressed in this section. It will be readily appreciated by those skilled in the art that two-light maskless photolithography is automated using other components and configurations of electronics, optics and mechanical hardware than those outlined below for a specific preferred embodiment of an apparatus.

The projection system comprises: a first and second light source 1; a first optics 23 that directs and collimates light from the sources to the SLM; a SLM 10 that selectively directs light from the first optics onto a substrate and mounted material on a stage 20 through a second optics 21. The automated apparatus is controlled from a computer 26, exclusively through a computer-based user interface that interfaces with a variety of components, including electronics 22. The electronics are a result of a combination of custom electronics, off-the-shelf modules, and three custom printed circuit board (PCB) assemblies.

The main interconnect PCB is the hub of the device. It houses the high powered LED drivers, the support circuitry for the projector, the power regulation, fan control and sensor inputs. An off-the-shelf data acquisition module, from National Instruments (Austin, Tex., US) controls most of the device. This USB module allows the computer to read sensor values and control the hardware. This approach eliminated the need to write firmware for a custom microcontroller. The second PCB is a custom optical encoder for the objective turret that provides feedback from sensor 18 to the software about the selected magnification level. The third PCB is a heat sink for the Nichia NCCU033 High Power UV LED, which generates several Watts of heat.

The stage 20 is a stepper-driven stage and provides sub-micrometer positioning accuracy. The stage is fitted to an inverted Olympus IX71 microscope 19. The stage motors are driven by an open-loop microstepping motor controller 24 from Trinamic (Hamburg, Germany). The motor controller receives commands from the computer via the mouse and keyboard 28 or the joy stick and buttons of the microstepping motor controller. The controller is able to move the stage independent of the computer. The center plate of the stage 20 is removed to allow changes in form factor of the substrate. For example, a 96 (or any other number) well plate holder can be exchanged for the standard slide holder.

The apparatus has two solid-state LED electromagnetic radiation sources: (1) the Nichia NCCU033 LED which produces 200 mW of 365 nm light from a 1 mm square die; and (2) the Luxeon III Star Amber LED P/N LXHL-LL3C which produces 100 lumens of 590 nm light. Each LED is controlled by a solid-state controller from Linear Technology (Milpitas, Calif., US). This controller provides precise intensity control without the color shift normally associated with dimming an LED. It uses a constant current output to provide a 3000:1 dimming range.

The apparatus has an infinity 2-1 digital camera 17 from Lumenera (Ottawa, Ontario, Canada) mounted to the inverted microscope that captures a superimposed image of the SLM pixels and the translucent mounted material through the transparent body of the substrate. This camera is an uncooled, 1.4 megapixel, CMOS camera. The camera captures at a frame rate of at least 15 fps over USB 2.0 and provides enough resolution to easily select regions of interest and does photo-documentation. An adapter is used to match the objective image magnification to the video image using a 0.35× magnification C mount adapter. A sensor 18 connected to the microscope objectives relays information regarding the magnification.

The SLM 10 is a DMD 0.7XGA 12° DDR (Texas Instruments, Inc., Dallas, Tex., US), and is driven by computer 26 via a DVI interface. This digital interface eliminates the noise and blurring associated with a standard analog VGA output. This is important for getting sharp, high contrast images without noise or flickering. All other functions of the projector are controlled by software over a RS-232 serial connection. This includes powering the unit on and off.

The user-interface communicates with the microscope-mounted instrumentation via software. The software provides a user-interface for creating, editing and applying light images to a mounted material. The software interfaces with a number of external devices via connecting computer cables 25. The software program provides a “paint” interface for creating a superimposed light image of the SLM with the mounted material while viewing the mounted material. Computer display 27 displays the superimposed images from camera 17. The identical superimposed images are also viewed directly through the microscope eyepieces. Software features provided by the user interface include a tool based editing interface with pen, filler and eraser tools, multi-level undo and redo, additional edit commands to clear and invert the light image, named procedures with procedure logs, ability to save and retrieve the light images as digital images stored as digital files, ability to capture camera images, commands to mark and return to exposure position, lamp brightness and camera exposure controls, and advanced dialogs for each hardware device.

The image displayed by the SLM is supplied from the second monitor output on the computer. When the software starts up, it creates a borderless window with the same pixel dimensions as the SLM, places this window on the second display which is the projected SLM pixel array, and outputs any stored digital image to this window. The SLM also has a serial port interface that is used to configure it. At power up, the software checks that it can communicate with the SLM and configures it as necessary. Because configuring the SLM is a time consuming task requiring long delays between each setting, the software queries the SLM's current configuration first and only changes settings that are incorrect.

The camera interfaces via USB and software drivers provided by the camera manufacturer. The camera software exposes a .NET interface permitting camera control from the programming language C#. The image displayed in the main window on the computer monitor 27 is a live video feed to a window controlled by the camera's own software. Software code written in C# makes the appropriate function calls to set this window up and adjust the camera settings, and then leaves the remaining functions to the camera software.

The stage 20 is controlled by a stage controller 24 containing a motion control processor manufactured by Trinamic. The stage controller 24 has an embedded program written in Trinamic's Motion Control Language (TMCL). This software is provided with the stage, but was modified for the specifics of the apparatus. The controller 24 takes input from both a joystick and a serial port connected to the computer. The joystick is used for primary control of the stage. The serial port allows the computer to get position updates, and to take over control of the stage when needed. For example, during an exposure, the software issues commands to the stage controller 24 to disable the joystick and move the stage to the position chosen for the exposure.

A combination of a National Instruments general purpose card and an additional custom card provides an interface to the nosepiece encoder, lamp brightness controls, and fan control. The interface to this National Instruments Card is via USB and software provided by National Instruments that includes a .NET interface. The nosepiece encoder/sensor allows the software to know what lens is selected and thus what portion of the digital image is visible in the edit window on computer monitor 27 at any time. The 590 nm LED is used as the electromagnetic radiation source when visualizing the mounted material and dynamically creating the digital image. The 365 nm LED is used as the electromagnetic radiation source when the mounted material is exposed after dynamic creation of the digital image for the purpose of causing the mounted material to substantially react. Fans for the projector and lamps are under software control, but are left on at all times.

The edit window and projected light image from the camera are aligned. For dynamic image editing to work properly, the software must be able to relate a point in the edit window to a pixel on the SLM array displayed by the camera. This is affected by both the alignment of the projection optics to the camera, and by the magnification of the particular microscope objective selected. To facilitate this alignment, the software includes a table with the left, right, top and bottom SLM pixel (i.e., coordinate) that is displayed by each microscope objective. A dialog is provided for entering this information during calibration. The encoder on the microscope nosepiece lets the software know which objective is selected, and thereby which set of numbers from the table to use.

The projected light image is aligned with the mounted material as the stage is moved. The stage can move and the projection optics is stationary. The software provides the illusion that the projected light image is fixed to the mounted material, moving with the slide as the stage is moved. To do this, the software keeps two digital images in memory. One is the digital image as dynamically edited by the user (i.e., the ‘final digital image’). The other is the digital image as displayed by the projection optics (i.e., the ‘displayed digital image’). When the stage is moved, the displayed digital image becomes a shifted version of the final digital image. When the user initiates the exposure with the 365 nm LED, the software moves the stage back to the exposure position and the displayed digital image becomes the same as the final digital image. Both the edit window to projected light image alignment and the projected light image to substrate alignment are maintained simultaneously.

2. Operation and Method of Use

The SLM 10 is controlled by a computer 26. The computer allows the user to visualize on monitor 27 the superimposed images of the SLM pixel array and the mounted material (translucent) and substrate (transparent) located on stage 20 via camera 17. Alternatively, the same superimposed images may be directly visualized in the microscope 19 ocular eyepieces. The movement of stage 20 in the x- and y-axis is controlled via the motor controller 24 or the mouse and keyboard 28. Movement of stage 20 allows the user to observe samples of various sizes. While manipulating the mouse and keyboard 28 of the user interface, the user may ‘paint’ regions of interest, or landmarks, within the mounted material while viewing the superimposed images through either the display monitor 27 or the eyepieces of microscope 19. The system allows the user to align the SLM with the mounted material, modulate a plurality of pixels in the SLM by selecting the one or more visual landmarks such that the pixels of the SLM assume a state, either ‘on’ or ‘off’, and transform the state to a digital representation, and thereby produce a digital image. Thus, the user creates a customized projected image dynamically while observing visual landmarks within the mounted material. The projected image so formed can be transformed to a digital image and saved in a computer as a digital file. Methods of use of an automated two-light photolithography apparatus are the same as the methods taught in sections ‘B. Single-Light Maskless Photolithography’ and ‘C. Two-Light Maskless Photolithgraphy’.

### E. EXAMPLES

### Example 1

### DNA Extraction and Quantitation from Mus Liver Tissue Slides

This example illustrates DNA extraction and quantitation from Mus liver tissue slides. Paraffin-embedded Mus liver tissue was used to prepare 4 μm thick tissue sections on positive charged glass slides. The tissue sections were deparaffinized with a series of baths: 1) xylene for 10 minutes; 2) 50:50 xylene/ethanol for 2 minutes; 3) ethanol for 10 minutes; 4) 50:50 xylene/ethanol for 2 minutes; and 5) xylene for 10 minutes. The samples were allowed to air dry.

A microscope was used to identify regions of interest within the deparaffinized Mus liver tissue sections and a tape stencil (3M 5425 tape stencil) with a central 4 mm aperture was then applied on top of the tissue section such that the center aperture encompassed the region of interest and formed a shallow well 0.5 mm in height above the tissue section. An SU-8 photoresist (negative photoresist) solution (MicroChem, Newton, Mass., US) was aliquoted (5 μl) into the well formed by the center aperture. These slides were then heated at 65° C. for 2 minutes, then immediately heated at 95° C. for 3 minutes, to drive off the photoresist solvent and form a solid photoresist film that coated the tissue section encompassed by the aperture. Separately prepared photoresist films were each irradiated for 15 seconds with 365 nm light containing a circular beam devoid of light, where the beam diameter measured either 0.6 mm, 0.8 mm, 1.0 mm, 1.25 mm or 1.5 mm. The sample slides were then heated at 65° C. for 2 minutes, then immediately heated at 95° C. for 3 minutes to complete the crosslinking reaction in the irradiated areas. Each slide was developed to remove the non-UV irradiated photoresist using a PGMEA bath with stirring for 10 minutes, followed by an isopropanol rinse. The samples were allowed to air dry.

A reaction vessel (RV) was applied to each of the developed liver tissue slides by removing the bottom adhesive of the RV, aligning the apertures of the RV and the stencil, and mating the RV to the stencil on the tissue slide. An extraction buffer solution (0.1 M Tris-Cl; 0.01 M EDTA, pH 8) was aliquoted (100 μl) into the reaction well of each RV and a screw cap mated to the RVs to form a vapor and liquid tight seal. The liver tissue sections with the RVs attached were incubated for 1 hr in a 37° C. oven. After incubation, the screw caps were removed and the extraction buffer solution discarded. Each reaction well of the RVs were rinsed twice with wash solution (0.1 M Tris-Cl, pH 8). An extraction solution (50 mM Tris-Cl, 1 mm EDTA, Proteinase-K (1 mg/ml), pH 8) was aliquoted (100 μl) into each reaction well. The samples were then incubated overnight in a 37° C. oven. The tissue lysates were individually transferred to separate microfuge tubes, and incubated at 80° C. for 30 minutes.

The amount of dsDNA within the tissue lysates was quantitated (Quant-It PicoGreen dsDNA Assay Kit, Molecular Probes, Eugene, Oreg., US) with fluorescence measured with a CytoFluor Series 4000 microtiter plate fluorometer (Perseptive Biosystems, Framingham, Mass., US).

Unirradiated photoresist films remained intact by microscopic examination, indicating that the photoresist film was not disrupted by the overnight Proteinase-K digestion. Conversely, the photoresist did not adversely affect the amount of dsDNA recovered from the tissue section as dsDNA relative to uncoated controls.

### Example 2

### dsDNA Extraction and Quantitation from Mus Kidney Tissue Slides

This example illustrates DNA extraction and quantitation from Mus kidney tissue slides. Paraffin-embedded Mus kidney tissue (4 μm thick) sections were mounted on glass slides (positive charged) and deparaffinized using xylene and ethanol baths. The Mus kidney tissue sections were observed microscopically to identify a region of interest (ROI). A tape stencil (3 M 5425) with a center aperture (4 mm diameter) was then applied as in Example 1. An SU-8 2015 (8% solids) photoresist solution with 0.25% SGL400 (Spectra Group Limited) and 0.31% OPPI (Spectra Group Limited) in cyclopentanone was aliquoted (7 μl) into the center well of the tape stencil. The tissue sections were pre-baked at 65° C. for 2 minutes, and then immediately heated at 95° C. for 20 minutes, to drive off the photoresist solvent and form a solid photoresist film that coated the tissue section encompassed by the aperture. After cooling to ambient temperature (˜25° C.), separately prepared photoresist films were each irradiated for 45 seconds with 405 nm light containing a circular beam devoid of light, where the beam diameter was varied. The slides were post-baked at 65° C. for 1 minute, then 95° C. for 3 minutes to complete the crosslinking reaction in the irradiated areas. The irradiated photoresist films were developed by immersing the slides in PGMEA for 30 seconds, followed by an isopropanol rinse.

A reaction vessel (RV) was applied to each of the liver tissue sections by removing the bottom adhesive of the RV, aligning the apertures of the RV and the stencil, and mating the RV to the stencil. An extraction buffer solution (0.1 M Tris-Cl; 0.01 M EDTA, pH 8) was aliquoted (100 μl) into the reaction well of each RV and a screw caps mated to the RVs to form a vapor and liquid tight seal. The liver tissue slides with the RVs attached were incubated for 1 hr in a 37° C. oven. After incubation, the screw caps were removed and the extraction buffer solution discarded. Each reaction well of the RVs was rinsed twice with wash solution (0.1 M Tris-Cl, pH 8). An extraction solution (50 mM Tris-Cl, 1 mm EDTA, Proteinase-K (1 mg/ml), pH 8) was aliquoted (100 μl) into each reaction well. The samples were then incubated overnight in a 37° C. oven. The tissue lysates were individually transferred to separate microfuge tubes, and incubated at 80° C. for 30 minutes.

The DNA extracted from the Mus kidney tissue slides was quantified using real-time quantitative PCR. A standard curve was generated using known amounts of Mus genomic DNA (Promega). The Mus housekeeping gene P-2-microglobulin was amplified from both Mus kidney and a Mus genomic DNA standard using forward primer (5′-ACCCGCCTCACATTGAAATCC-3′) [SEQ ID NO. 1] and reverse primer (5′-CGATCCCAGTAGACGGTCTTG-3′) [SEQ ID NO. 2] and FastStart SybrGreen Master Mix (Roche) with the following thermocycling protocol: Step 1) 95° C. for 10 minutes; Step 2) 95° C. for 15 seconds; 60° C. for 1 minute (repeated 40 times); Step 3) 95° C. for 15 seconds; and Step 4) 60° C. for 20 sec, with a ramp time of 19 minutes, 59 seconds to 95° C. for 15 seconds. The dsDNA from the Mus kidney tissue sample lysates were also quantitated using a fluorescent dye (Quant-It PicoGreen dsDNA Assay Kit, Molecular Probes, Eugene, Oreg., US).

Quantitation indicated DNA was recovered from photoresist coated Mus kidney tissue that was exposed to light containing a beam devoid of light, such that photoresist had been substantially removed in the area devoid of light, thereby exposing the underlying tissue to extraction solution. Photoresist coated tissue sections that were flood exposed to light (i.e., no beam devoid of light) resulted in a completely intact photoresist film that precluded contact of the extraction solution with the tissue section, and yielded no detectable DNA.

### Example 3

### Generation of a Photoresist Overlay on Mus Liver Tissue Slides

This example illustrates DNA extraction and quantitation from Mus liver tissue slides. Paraffin-embedded Mus liver tissue was used to prepare 4 μm thick tissue sections on positive charged glass slides. The liver tissue sections (n=24) were deparaffinized with a series of baths: 1) xylene for 10 minutes; 2) 50:50 xylene/ethanol for 2 minutes; 3) ethanol for 10 minutes; 4) 50:50 xylene/ethanol for 2 minutes; and 5) xylene for 10 minutes. The samples were allowed to air dry.

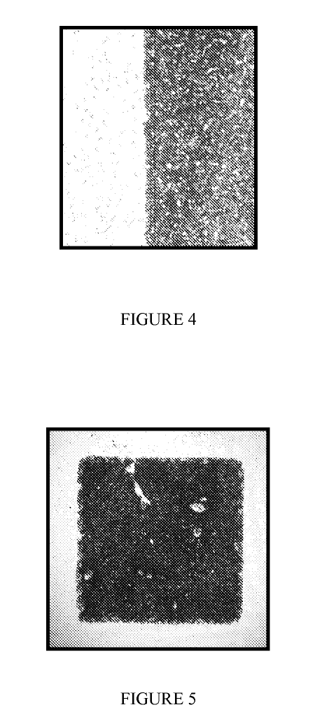

The Mus liver slides were observed microscopically to identify a region of interest (ROI). A tape stencil (3M 5425) with a center aperture (4 mm diameter) was then applied on top of the tissue section as in Example 1. A photoresist solution containing EPON resin SU-8 (21%), Tone polyol 0305 (1.5%), and triarylsulfonium hexafluoroantimonate (1%) was aliquoted (5 μl) into the well of the tape stencil. The specimens were pre-baked at 90° C. for 7 minutes to drive off the photoresist solvent and form a solid photoresist film. The specimens were cooled to ambient temperature (˜25° C.). Images were generated using an automated two-light photolithography system as follows; while viewing an image of the Mus liver tissue slide using the microscope and the nonreactive 590 nm light, a computer was used to selectively turn “on” and “off” individual pixels of a DMD such that half of the image was irradiated with UV light (365 nm) for 45 seconds. The samples were post-baked at 90° C. for 6 minutes. The imaged photoresist was developed by immersing the sample slide in PGMEA for 30 seconds, followed by an isopropanol rinse. Removal of the unpolymerized photoresist was confirmed by microscopic observation (FIG. 4)

### Example 4

### Generation of a 100×100 Pixel Square Over Mus Tissue

This example illustrates DNA extraction and quantitation from Mus liver tissue sections. Paraffin-embedded Mus liver tissue was used to prepare 4 μm thick tissue sections on positive charged glass slides. The liver tissue sections (n=24) were deparaffinized with a series of baths: 1) xylene for 10 minutes; 2) 50:50 xylene/ethanol for 2 minutes; 3) ethanol for 10 minutes; 4) 50:50 xylene/ethanol for 2 minutes; and 5) xylene for 10 minutes. The samples were allowed to air dry.

The Mus liver slides were observed microscopically to identify a region of interest (ROI). A tape stencil (3 M 5425) with a center aperture (4 mm diameter) was then applied on top of the tissue section as described in Example 1. A photoresist solution containing EPON resin SU-8 (21%), Tone polyol 0305 (1.5%), and triarylsulfonium hexafluoroantimonate (1%) was aliquoted (5 μl) into the well of the tape stencil. The specimens were pre-baked at 90° C. for 7 minutes to drive off the photoresist solvent and form a solid photoresist film. The sample slides were cooled to ambient temperature (˜25° C.). Images were generated using an automated two-light photolithography system as follows; while viewing an image of the Mus liver tissue slide using the microscope and the nonreactive 590 nm light, a computer was used to selectively turn “on” and “off” individual pixels of a DMD such that the photoresist was irradiated with UV light (365 nm) for 45 seconds that containing a 100 pixel×100 pixel area that was devoid of light; that is, contained all ‘off’ pixels (an approximate 1.4 mm×1.4 mm square). The samples were post-baked at 90° C. for 6 minutes. The imaged photoresist was developed by immersing the sample slide in PGMEA for 30 seconds, followed by an isopropanol rinse. Removal of the unpolymerized photoresist was confirmed by microscopic observation (FIG. 5).

The amount of dsDNA within the tissue lysates was quantitated as in Example 1 above (Quant-It PicoGreen dsDNA Assay Kit, Molecular Probes, Eugene, Oreg., US) with fluorescence measured with a CytoFluor Series 4000 microtiter plate plate fluorometer (Perseptive Biosystems, Framingham, Mass., US). The recovered lysate was determined to contain 0.65 μg/ml of dsDNA.

### Example 5

### Generation of a 30×30 Pixel Square Over Mus Tissue

This example illustrates DNA extraction and quantitation from Mus liver tissue sections. Paraffin-embedded Mus liver tissue (4 μm thick) sections mounted on glass slides (positive charged) were deparaffinized using xylene and ethanol baths as described above.

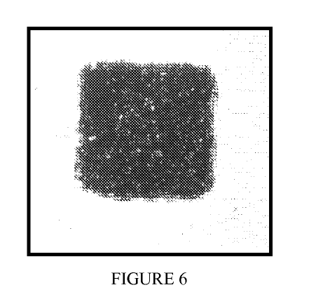

The Mus liver sections were observed microscopically to identify a region of interest (ROI) and the specimens processed as in Example 4 above, except the area devoid of light was a 30 pixel×30 pixel area (an approximate 0.4 mm×0.4 mm square). Removal of the unpolymerized photoresist was confirmed by microscopic observation (FIG. 6).

The amount of dsDNA within the tissue lysates was quantitated (Quant-It PicoGreen dsDNA Assay Kit, Molecular Probes, Eugene, Oreg., US) with fluorescence measured with a CytoFluor Series 4000 microtiter plate plate fluorometer (Perseptive Biosystems, Framingham, Mass., US). The recovered lysate was determined to contain 0.35 μg/ml of dsDNA.

### Example 6

This example illustrates an application of the preferred instrument in the collection of a large database of gene expression patterns of both healthy and diseased tissue, at different stages of diseases. This database will be used to more fully understand that pathogenesis of cancer and infectious diseases. Gene patterns are identified and correlated to predictive diagnostic tests.

All publications, patents, and patent applications cited herein are hereby incorporated by reference in their entirety for all purposes.

We claim:

1. A method for generating a digital image comprising: (a) providing a substrate with a mounted material having one or a plurality of visual landmarks; (b) aligning a spatial light modulator with the substrate wherein the spatial light modulator comprises a plurality of pixels; (c) selecting the one or more visual landmarks on the substrate such that the pixels of the spatial light modulator assume a state; and (d) transforming the state to a digital representation, and thereby producing a digital image.

2. The method for generating a digital image of claim 1, wherein the one or more visual landmarks are selected from the group consisting of organs, tissues, cells, organelles and molecules.

3. The method for generating a digital image of claim 1, wherein the spatial light modulator is a digital micromirror device or a liquid crystal device.

4. The method for generating a digital image of claim 1, further comprising storing the digital representation in a computer.

5. The method for generating a digital image of claim 1, wherein step (b) further comprises projecting light through a spatial light modulator, thereby illuminating the mounted material.

6. The method for generating a digital image of claim 1, wherein selecting the one or more visual landmarks in step (c) comprises using a microscope.

7. The method for generating a digital image of claim 1, further comprising projecting the digital image onto the mounted material using light.

8. The method for generating a digital image of claim 8, wherein the light causes a mounted material to substantially react.

9. The method for generating a digital image of claim 1 further comprising: (e) moving the spatial light modulator and repeating steps (b)-(d), thereby forming a plurality of digital representations; and (f) merging the plurality of digital representations together, and thereby producing a digital image.

10. The method for generating a digital image of claim 9, wherein moving the spatial light modulator in step (e) further comprises scrolling the state across the spatial light modulator such that the one or more visual landmarks remain in a fixed spatial relationship to at least a portion of the state.

11. The method for generating a digital image of claim 9, wherein the plurality of digital representations are from about 2 to about 1000 digital representations.

12. The method for generating a digital image of claim 9, wherein the plurality of digital representations are from about 11 to about 1000 digital representations.

13. The method for generating a digital image of claim 9, wherein the digital representations are at least partially overlapping each other.

14. The method for generating a digital image of claim 9, wherein the digital representations are not overlapping each other.

15. A device for generating a digital image, comprising (a) an electromagnetic radiation source that emits a light; (b) a microscope with an objective lens; (c) a spatial light modulator positioned to direct the light into the objective lens to provide an image comprising a plurality of pixels in the spatial light modulator; and (d) a computer connected to, and controlling the plurality of pixels, and capable of transforming a state of the plurality of pixels into a digital representation, wherein the digital representation is a digital image.

16. The device for generating a digital image of claim 15, further comprising an mounted material having one or more visual landmarks, and the mounted material is positioned between the spatial light modulator and the objective lens.

17. The device for generating a digital image of claim 16, wherein the mounted material is mounted on a movable platform.

18. The device for generating a digital image of claim 16, wherein the light from the spatial light modulator is reflected off the mounted material into the objective lens.

19. The device for generating a digital image of claim 16, wherein the light from the spatial light modulator substantially reacts on or within the mounted material.

20. The device for generating a digital image of claim 15, wherein the electromagnetic radiation source is a plurality of selectable electromagnetic radiation sources that emit light of different wavelengths from each other.

21. The device for generating a digital image of claim 15, wherein the electromagnetic radiation source is a light-emitting diode.

22. The device for generating a digital image of claim 15, wherein the spatial light modulator is a digital micromirror device or a liquid crystal device.

23. The device for generating a digital image of claim 15, further comprising (a) a lens between the electromagnetic radiation source and the spatial light modulator; and (b) a lens between the spatial light modulator and the objective lens.

24. The device for generating a digital image of claim 15, further comprising a means to digitally capture the image of a plurality of pixels in the spatial light modulator.


SEQUENCE LISTING (2 sequences)

SEQ ID NO: 1 - DNA, 21 bp, artificial sequence
  zebra fish
acccgcctcacattgaaatcc

SEQ ID NO: 2 - DNA, 21 bp, artificial equence
  zebra fish
cgatcccagtagacggtcttg